(19) United States
(12) Patent Application Publication
(10) Pub. No.: US 2006/0165260 A1
(43) Pub. Date: Jul. 27, 2006

(54) Product authenticity validation system

(76) Inventors: Govind W. Vanjani, Danbury, CT (US); Jerold I. Schneider, Rockville, MD (US)

Correspondence Address: AKERMAN SENTERFITT, P.O. BOX 3188, WEST PALM BEACH, FL, 33402-3188, US

(21) Appl. No.: 11/038,046

(22) Filed: Jan. 21, 2005

(51) Int. Cl. G06K 9/00

(52) U.S. Cl. 382/115; 340/5.9; 340/5.8; 705/1; 235/375

(57) ABSTRACT

A method, system and apparatus for verifying the authenticity of a product are described. A verification center is maintained which can communication with a database. A verification card is supplied to a consumer in association with a product whose authenticity is to be verified. The consumer can contact the verification center and convey a unique identifier found on the verification card. Records stored in the database are checked to determine if the unique identifier is genuine and if the unique identifier has been previously conveyed. If the unique identifier is not genuine or has been previously conveyed, the consumer is informed that the product may be counterfeit. If the unique identifier is genuine and has not been previously conveyed, the consumer is informed that the product is authentic and record is made in the database indicating that the unique identifier has been conveyed.

### TECHNICAL FIELD

A system, method and apparatus for validating the authenticity of products.

### BACKGROUND

Many products bear labels that indicate their nature and origin. Consumers rely on such labeling to ensure that they are purchasing the products they want. However, recent advances in printing and duplicating technologies have made it easy for counterfeiters to produce unauthorized goods that are difficult to distinguish from authenticate goods. The sale of counterfeit goods costs rightful manufacturers and distributors vast amounts of money in lost sales per year. Moreover, these unauthorized goods are often of inferior quality. Thus, their circulation in the market place can harm the good will and reputation of the true manufacturer. Such difficult-to-quantify, intangible damage can be very difficult to repair or even detect.

Non-limiting examples of industries that suffer from counterfeiting are the entertainment, multimedia, pharmaceutical, health and beauty aids, apparel and accessories industries. All of these industries are vulnerable to counterfeiting because of the easily reproducible products that they market, many of which are also associated with a famous style, appearance and/or trade mark. Despite the best efforts of manufacturers, counterfeiting continues to thrive.

Another source of “counterfeit” goods can be manufacturers operating under a license or agreement to produce a limited quantity of authorized goods. Such an arrangement can lead to the problem of licensed producers manufacturing excess quantities of the goods, those manufactured in excess of the authorized quantity being considered as unauthorized or counterfeit. The unauthorized products can be indistinguishable from the authorized products, appearing and performing identically thereto. Original equipment manufacturers (OEMs) are, out of necessity, entrusted with the complete specifications and technical assistance to produce the authorized products. Unfortunately, unscrupulous OEMs have been known to use these specifications and know how to produce unauthorized copies of the product in addition to those produced for the authorizing manufacturer. These unauthorized copies can be sold to distributors or retailers at discounts. In addition, some authorized products which have failed a quality control procedure, and are thus unauthorized or “counterfeit”, have been sold to distributors or retailers at discounts. To the consumer, and sometimes even the retailer, the unauthorized copies cannot be distinguished from the authentic products.

The problem of counterfeit goods is not limited to the above-mentioned industries. Other unauthorized items that are commonly pawned off as brand name, authentic goods include clothing, purses, watches, jewelry, other fashion accessories, electronics, such as cellular or portable telephones, radios and personal CD players, CD's, DVD's, CD ROM's, music, “books on tape”, movies, computer software, books, as well as advertised and respected non-durable items, such as pharmaceuticals (both prescription and ‘over-the-counter) and the like. The present system is applicable to any of these products and others that are vulnerable to counterfeiting (including manufacturing overruns (i.e., quantities in excess of the authorized quantity), rejects from quality control procedures, and even authorized quantities of goods (e.g., clothing) which have not been sold and/or have been returned to the manufacturer.

### SUMMARY

A system, method and apparatus for verifying the authenticity of goods and for detecting or preventing counterfeiting. The method involves a verification center in communication (direct or indirect) with a database. A verification card, which has a unique identifier and contact information for the verification center, is supplied to a consumer in association with the product whose authenticity is to be verified. The consumer is prompted to contact the verification center and convey the unique identifier. In response to receipt of the unique identifier, records stored in the database are checked to determine if the unique identifier is genuine and if the unique identifier has been previously conveyed. If the unique identifier is not genuine or has been previously conveyed, the consumer is informed that the product may be counterfeit. If the unique identifier is genuine and has not been previously conveyed, the consumer is informed that the product is authentic and a record is recorded in the database indicating that the unique identifier has been conveyed.

The method can be implemented using a system in which the verification center includes a voice response unit that is accessible to remote users through a communications network. The database has stored therein a plurality of unique identifiers and data indicative of whether or not each of the unique identifiers has been conveyed previously. The system can involve a plurality of verification cards. Each of the verification cards can be associated with an authentic product whose authenticity is to be verified. The verification cards include contact information for the verification center and a unique identifier corresponding to one of the unique identifiers stored in the database.

The method, system and apparatus also can be implemented with a multi-level verification. For example, on a shipment of products to a retailer, there can be a master verification card for the entire shipment, and then separate verification cards for each product within the shipment. The retailer can verify the entire shipment before providing the products to consumers and the consumers can separately verify their individual purchases. This multi-level verification is not restricted to any particular type of products, and the verification can take place at various levels, e.g., distributor, retailer and consumer.

The system, method and apparatus can further include an incentive or ‘reward’ for the person (wholesaler, retailer, consumer) for participation in the product verification process. The person who proceeds with product verification may be provided with a discount for a future purchase, a partial refund for the purchase, or other incentive or promotional item. Whether or not the verification card is a pre-paid telephone calling card, the person who proceeds with product verification can be provided with a pre-paid telephone calling card of a particular value.

### BRIEF DESCRIPTION OF THE DRAWINGS

For the purpose of illustration only, there are shown in the drawings forms which are presently preferred; it being understood, that this system, method and apparatus are not limited to the precise arrangements and instrumentalities shown.

FIG. 1 is a flowchart showing validating the authenticity of goods according to one embodiment.

FIG. 2, comprising FIG. 2a and FIG. 2b, is a flowchart showing validating according to a second embodiment.

FIG. 3 is a schematic diagram according to an embodiment of the invention.

FIG. 4 is a flowchart showing multi-level validating the authenticity of goods.

### DETAILED DESCRIPTION

It will be appreciated that the following description is intended to refer to specific embodiments selected for illustration in the drawings and is not intended to define or limit the system, method and apparatus, except as they may be expressly limited in the appended claims.

In the figures, in which like reference numerals indicate like elements, there are shown preferred methods and a preferred system for verifying the authenticity of a product. Such a product may be any good or service that is prone to counterfeiting, such as, but not limited to those discussed above. As used herein, the term “prone to counterfeiting” means capable of being counterfeited. The terms “product”, “product that a consumer has purchased” and the like include those that a consumer has already purchased or is considering purchasing, as well as those received as gifts or otherwise legitimately acquired without monetary payment. As used herein the term “counterfeit” includes not only non-genuine products, but also products rejected during quality control procedures, deliberate or accidental manufacturing overruns (excess quantities), returns, authorized quantities which have not been sold, products authorized only for certain countries (which, for example, have thereafter been sold in an different country), and any other situation where there is to be some form of control on the quantity, or quality or destination of products, or any feature of product, etc.

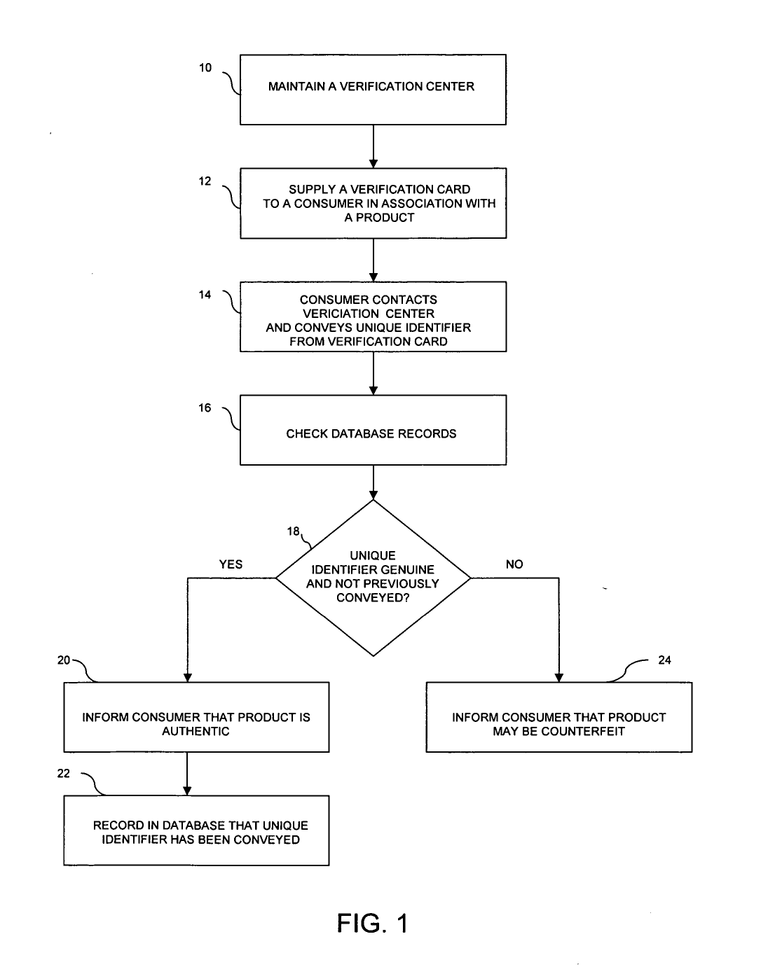

FIG. 1 is a flowchart showing various steps according to a first embodiment. As indicated in box 10, a verification center is maintained in communication with a database having records corresponding to genuine unique identifiers. The verification center can be located remotely from a point of sale where the consumer purchases the product whose authenticity is to be verified. Such products may be sold in diverse types of stores across a wide geographic area, possibly across the country or even around the world, and including Internet sales. Thus, the verification center can be accessible to consumers that purchase products at points of sale located throughout a wide area. The verification center can be accessible via a communication network, such as a telephone system, VoIP (Voice over Internet Protocol), electronically, e.g., by computer or via the Internet. Thus contact with the communication network may be either hard-wire, wireless, cellular telephone or combinations, and may be over public or proprietary networks.

A verification card is supplied to the consumer in association with the product whose authenticity is to be verified, as shown in box 12. The verification card includes a unique identifier, preferably in the form of a PIN (personal identification number). The unique identifier provided on each verification card corresponds to a unique identifier stored in the database in communication with the verification center. The unique identifier can be concealed by a removable masking until the time that the product is purchased. The removable masking can be, for example, a conventional scratch-off material that can be easily removed by the consumer. Scratch-off material is difficult to replace once removed, and if removed prior to the time of purchase, can be indicative of tampering with the verification card.

The verification card can be associated with the product by including the card inside the product packaging or by affixing the card to the product or product packaging prior to shipment to the point of sale. If the verification card is affixed to the packaging, it is preferably affixed in a manner that will indicate any attempted removal or other tampering with the verification card. Tamper-evident methods of attachment are known in the packaging arts. For example, the package or the verification card can be provided with tamper evident printing that will delaminate if the card is detached from the package. Alternatively, the packaging or verification card can be of multi-layer construction, in which the adhesive used to affix the card to the package is stronger than a cavitated or other weak internal layer in the card or package so that the cavitated layer fails if the card is separated from the packaging. Other methods of tamper evident attachment are also known.

The consumer can be prompted to contact the verification center to determine if the product that has been purchased is authentic. Along with the prompt, a warning can be provided to the consumer that the absence of a verification card may indicate a counterfeit product. The prompt can be in the form of instructions on the verification card, a message printed on the packaging, a separate label associated with the package, or by way of advertising on television, radio, printed publication or the like. The prompt can be, for example, a simple message such as “Call the number shown on your verification card”, or can include contact information for the verification center, such as “Call” followed by a telephone number or “visit” or “contact” followed by a website URL. To enhance the likelihood that the consumer will contact the verification center, the contact information for the verification center may be a toll-free telephone number printed on the verification card or a URL.

Using the contact information, the consumer can contact the verification center and convey the unique identifier included on the verification card, as shown in box 14. When the verification center receives the unique identifier, the database can be polled, as at box 16, to check if there is a record stored corresponding with the unique identifier. If a corresponding record is found in the database, the unique identifier can be considered genuine. If the unique identifier has no corresponding record in the database, the unique identifier can be considered not genuine. As shown in decision box 18, the database can also be polled to determine if the unique identifier has been previously conveyed.

If the unique identifier is found to be genuine and has not previously been conveyed, the consumer can be informed that the product is authentic, as in box 20. In addition, a record can be recorded in the database, as in box 22, indicating that the unique identifier has been conveyed so that if the same unique identifier is subsequently conveyed, the database polling will reveal that the unique identifier has previously been conveyed.

If it is determined that the unique identifier is not genuine or that the unique identifier has been previously conveyed, the consumer can be informed that the purchased (or acquired by gift, etc.) product may be counterfeit as indicated in box 24. Because both conditions (i.e., the unique identifier is genuine and has not previously been conveyed) must be met in order for the consumer to receive a message indicating that the product is authentic (box 20), the consumer may receive the message indicating that the product may be counterfeit (box 24) even if the product is, in fact, authentic. An alternate message may be that the unique identifier has been previously used. This may be the case if the consumer contacts the verification center twice using the same unique identifier or if the consumer later sells or gives the product to another, who then calls the verification center and provides the unique identifier. Thus, it is preferred that an explanation to this effect be included with the message of box 24 and/or the general instructions and/or any prompt provided to the consumer upon calling or otherwise contacting the verification center.

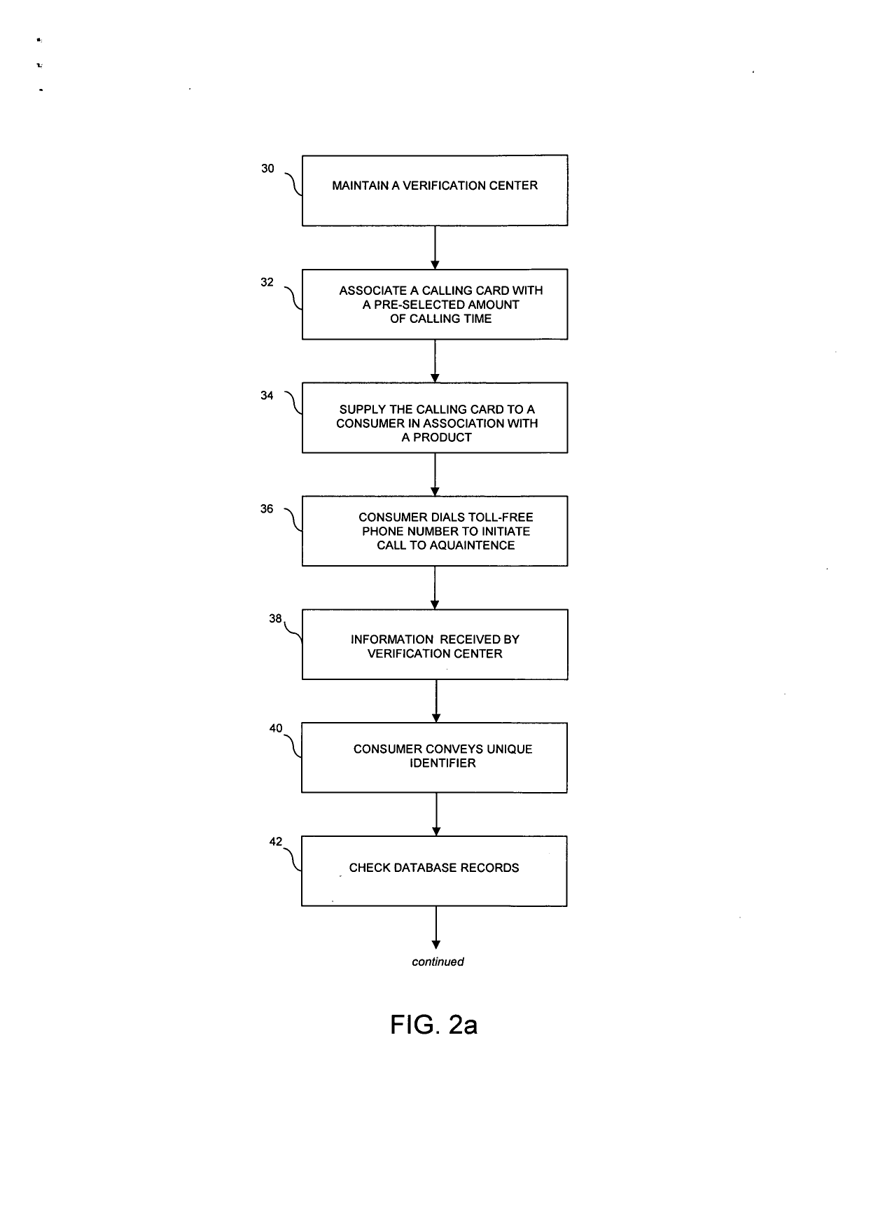

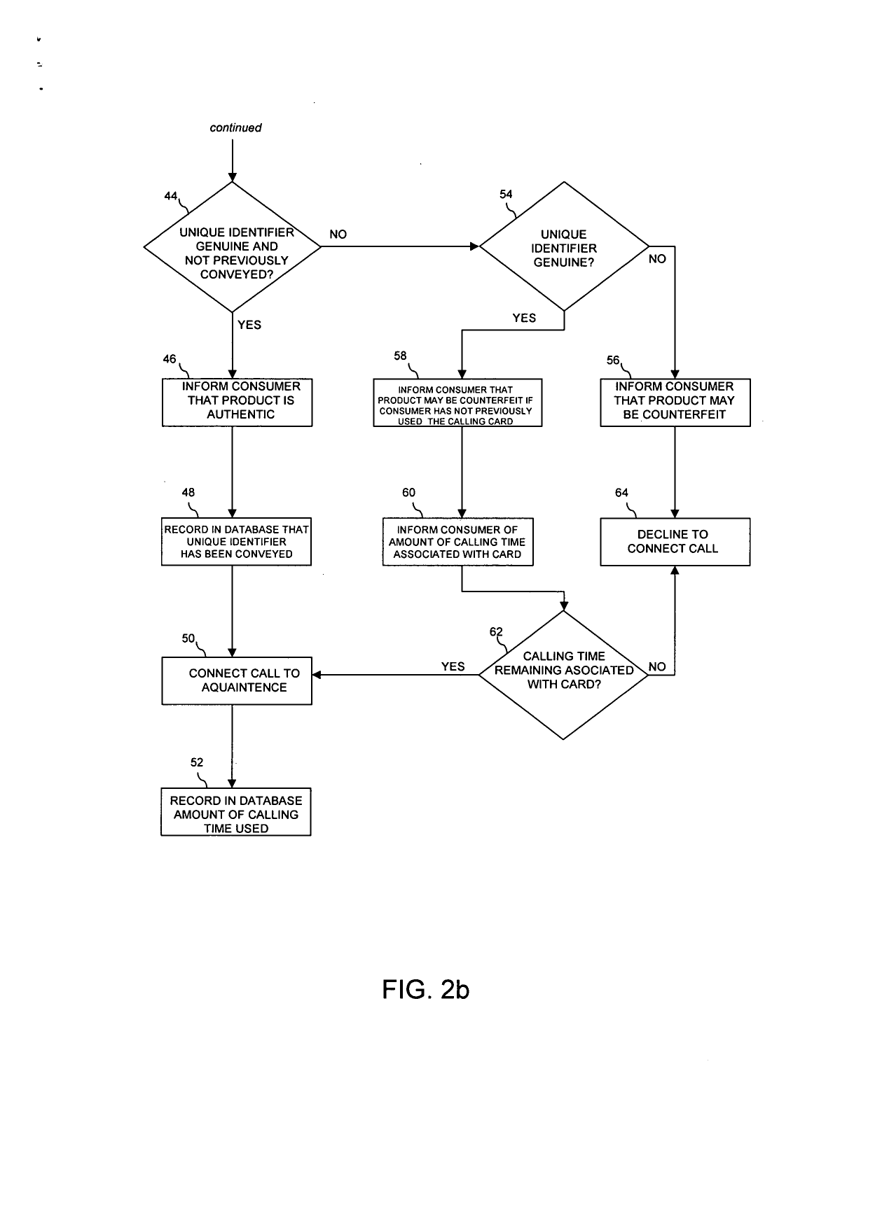

One embodiment of the method is shown in FIG. 2, in which the step of maintaining a verification center is indicated in box 30. According to this embodiment, the verification card is a prepaid calling card. As shown in box 32, the method involves associating the calling card with a preselected amount of calling time. This can be five minutes or some other amount of calling time that is desired to be given away. The calling card is supplied to a consumer in association with the product, as shown in box 34. In this embodiment, the contact information for the verification center is a toll-free telephone number. Information provided with the product can inform the consumer that the calling card may be used to telephone an acquaintance, such as a friend, family member, business associate, etc., of the consumer's choice. Further information may also be provided regarding how the calling card can be used in accordance with the method described below to verify the authenticity of the product.

The consumer contacts the verification center by dialing the toll-free telephone number provided with or on the calling card to initiate the call to the acquaintance, as shown in box 36. The call to the toll-free number is answered by the verification center, as at box 38. The consumer can then be prompted to convey the unique identifier, by entering the number on a telephone keypad or by speaking the number if a voice response unit with appropriate voice recognition software is provided at the verification center. The consumer may also be prompted for the telephone number of the acquaintance he or she wishes to call at this time or at any other time prior to connecting the call to the acquaintance (see box 50 described below). Apparatus for accomplishing the foregoing (e.g., a Voice Responsive Unit or IVR for pre-paid telephone calling cards), exists such as the NMS (Natural Microsystem IVR and the ICS (Industrial Computer Source) IVR. However, such apparatus have not heretofore been used for verification of product authenticity.

As indicated at box 42, the database can be queried to determine if the unique identifier is genuine and whether or not the unique identifier has been conveyed previously. If, at box 44, it is determined that the unique identifier is genuine and has not been previously conveyed, the consumer can be informed that the product that he or she has purchased is authentic as shown at box 46. It can then be recorded in the database that the unique identifier has been conveyed, as at 48, and the call to the acquaintance can be connected as shown at box 50. Further, once the call has been terminated, at step 52, a record can be entered in the database in association with the unique identifier indicating the amount of calling time that was used during the call.

As is known in the pre-paid telephone calling card technology, the database will include information as to active PINS (i.e., active unique identifiers), rate decks or rate tables to indicate the “cost” for local, long distance and international telephone calls, the amount of remaining “value” on the prepaid telephone calling card, etc. The manufacturer desiring to use the present method, apparatus and system communicates with the database to indicate the active “PINS”, i.e., to indicate the identifiers which are genuine. Then, in response to use by the consumer, the database software then confirms that the identifier is genuine. Existing systems, although not heretofore used for product verification, include Synapsys Nucleous Prepaid Calling Card Platform and Cirilium Worldtalk Net Prepaid Software.

If, at decision box 44, it is determined that both conditions are not met, the next step of the method can depend upon which condition failed. If the unique identifier is not genuine, the consumer can be informed that the product may be counterfeit, as shown at box 56. In addition, the consumer can be informed that the connection of the call to the acquaintance has been declined, as indicated at box 64.

If, on the other hand, the unique identifier is genuine (e.g., it matches one of the unique identifiers stored in the database), the consumer can be informed that the product may be counterfeit if the consumer has not previously used the calling card, as shown at box 58. A similar explanation as that described above in connection with box 24 may also be provided. If desired, the database can also be queried to determine how much calling time remains associated with the card, and the consumer can be informed of the remaining amount, as shown at box 60. If, at decision box 62, it is determined that no calling time remains associated with the card, the system can decline to connect the call as shown at box 64, and advise the consumer accordingly. Of course, if it is determined that calling time remains associated with the card, then the call can be connected to the acquaintance and the duration of the call recorded in the database, as shown in boxes 50 and 52.

It will be appreciated by those skilled in the art that the method shown in FIG. 2 may be further enhanced with various steps. For example, if the calling time remaining associated with the card expires during a call to the acquaintance, the call can be terminated. Warnings of impending termination can be provided to the consumer as the time remaining associated with he card approaches expiration.

According to either method, the consumer can be a representative of the authorizing manufacturer. The representative can purchase the product as would another consumer, contact the verification center and convey the unique identifier on the associated verification card. Thus, the product manufacturer can test a retailer to determine if the retailer is selling counterfeit or authentic products.

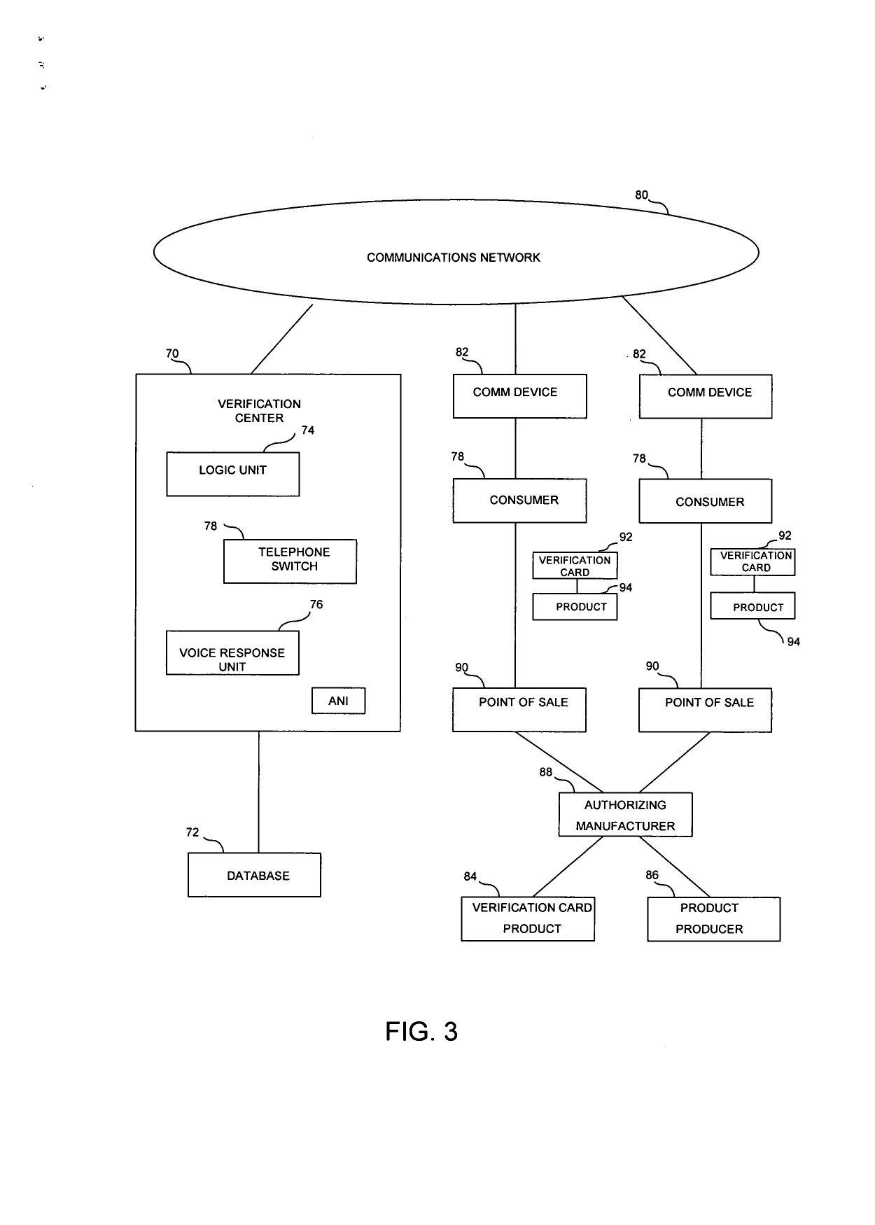

An embodiment of a system that can be used to implement the method is shown in FIG. 3, which shows a verification center 70 in communication with a database 72. The database 72 has stored therein a plurality of unique identifiers and data indicative of whether or not each of the unique identifiers has been conveyed by a consumer to the verification center. The unique identifiers may be conveyed to or communicated to the database by the manufacturer or by a trusted source. In this embodiment, the database further includes information indicative of how much calling time remains associated with each unique identifier.

The verification center can include a logic unit 74, which may be a central processing unit (CPU), and a voice response unit 76. In the embodiment in which the verification card is a prepaid calling card, the verification center can also include a telephone switch 78 for connecting calls from a consumer to his or her acquaintance.

The hardware of the verification center 70 can be adapted to receive the unique identifier associated with a verification card from a consumer. In addition, the hardware can be adapted to poll the database to determine if the unique identifier is valid and if the unique identifier has been previously conveyed. Also, the hardware can be adapted to prompt the voice response unit to provide an appropriate response to the consumer regarding the authenticity of the product after polling has been preformed.

In implementations involving a prepaid calling card as the verification card, the logic unit 74, voice response unit 76 and telephone switch 78 can work together to answer and connect calls in a manner similar to that described in U.S. Pat. No. 6,463,137 to Vanjani et al., which was issued Oct. 8, 2002 and is incorporated herein by reference in its entirety. The verification center may also be responsive to ANI information supplied by the telephone company to record the phone number of the incoming phone call. The database can be queried to determine various information including but not limited to all ANI information associated with invalid identifiers, so that an investigation can be undertaken to determine the potential source of counterfeit products.

It should be noted that the configuration of the verification center can be altered from that shown in the drawing. For example, the database 72 may be within the verification center. As such, the term “in communication with” encompasses an internal device as well as an external device connected to the referenced entity by wired or wireless communications. Conversely, it would also be possible to place the logic unit 74, response unit 76 or telephone switch 78 externally to the verification center 70, as long as satisfactory communication can be maintained between these elements and the verification center 70.

The verification center 70 is accessible to consumers 78 through a communications network 80 and communication devices 82, which are typically local to the consumers. The communications network 80 can be a public telephone system involving local and long distance carriers, or can be a proprietary system, such as that described in U.S. patent application Ser. No. 09/392,474, which was filed Sep. 9, 1999 and is incorporated herein by reference in its entirety. The communication devices 82 can be standard telephones, cellular telephones or any other device capable of interfacing with the telephone communication network, such as a voice-enabled computer (VoIP) and may be suitably modified for Internet communication. In fact, non-voice communication (e.g., via the Internet) is also contemplated.

The implementation system also preferably includes a verification card producer 84 that is distinct from the product producer 86. Here, the product producer can be a licensed original equipment manufacturer or other producer making products for an authorizing manufacturer 88. If the verification cards are produced at a location different from where the products are produced, then the authorizing manufacturer 88, which desires to alleviate or prevent a counterfeiting problem, can associate the verification cards with the product. This can eliminate the possibility that the product producer 86 could supply overrun or otherwise unauthorized products into the stream of commerce with valid verification cards.

An alternative is to have products shipped from the product producer 86 to the verification card producer 84, where the verification cards can be associated with the product. Another alternative is to use a third party to associate the verification cards with the products. A still further alternate is to provide the verification cards to the product producer for inclusion with the product. However, if the product producer is empowered to associate the verification cards with the products, it is preferred that a strict accounting system be implemented for tracking the number of verification cards provided to the product producer for association with products.

Regardless of the specific implementation, each product 94 can be provided to retailers or other point of sale locations 90 in association with a verification card 92. Thus, when the consumer purchases the product 94 at the point of sale 90, the consumer is supplied with the associated verification card 92.

Another alternative which is contemplated by the present method, system and apparatus, is an incentive-based approach to enhance the likelihood of consumer use of the verification feature. Thus regardless of whether the consumer is contacting the verification center by telephone, VoIP, Internet or in any other manner, the system can provide an incentive to the consumer in the form of a discount for a future purchase, a partial rebate, or a pre-paid telephone calling card. Thus the consumer calling the verification center (which may be electronically operated or a call center, or combinations, etc.) may be given a choice of incentives. Similarly, it is contemplated that if the consumer calls a toll-free number and uses the PIN, the consumer can be given, over the phone lines, a second toll-free number to use with the same PIN, for a predetermined amount of pre-paid calls. Indeed, this type of incentive may be used regardless of how the consumer contacts the verification center, and the database can track the ANI information (or computer information when Internet access to the verification center is used) to determine if situations suggesting misuse of the system arise.

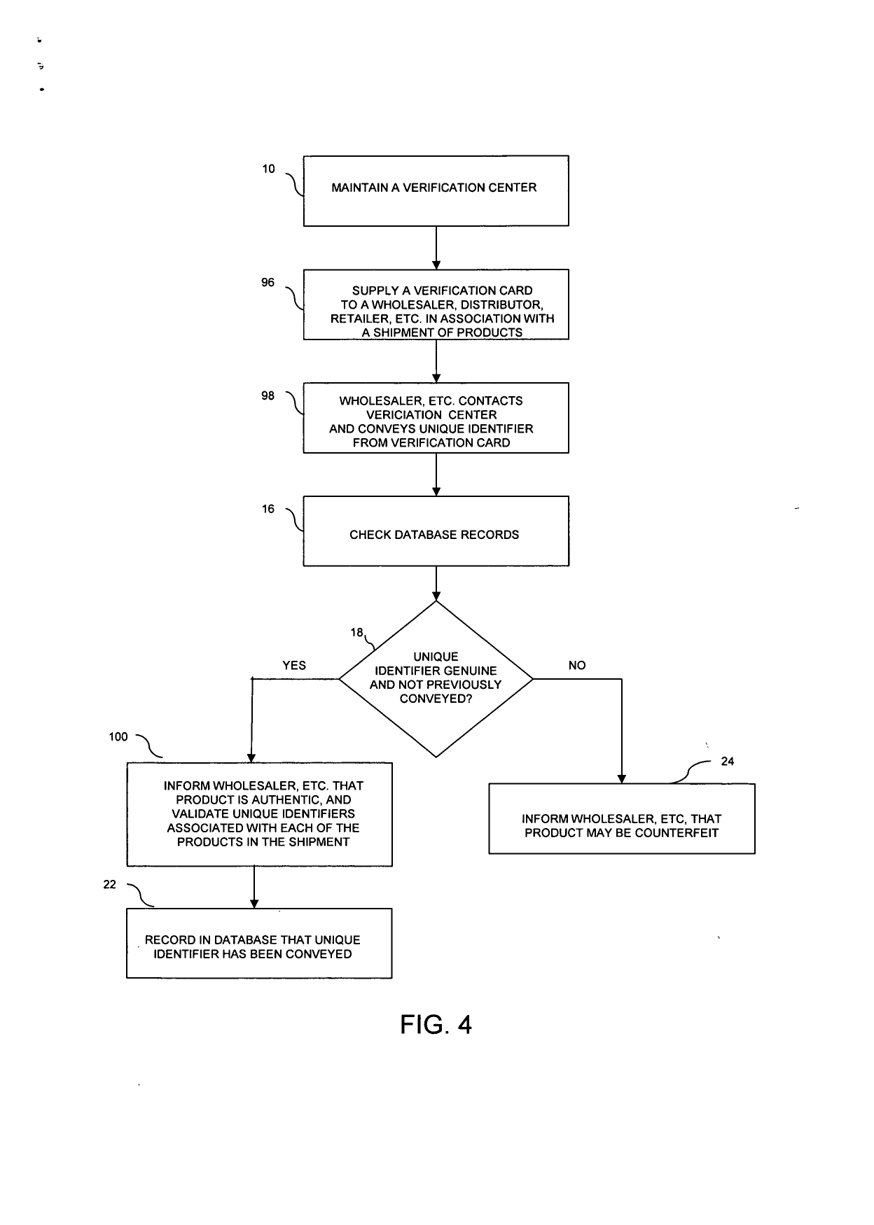

FIG. 4 illustrates additional alternatives such as the requirement that a wholesaler, distributor or retailer call to verify the authenticity of a shipment, and this call then serves to validate the identifiers associated with a particular shipment. In box 10 the verification center is maintained in communication with the database 16 having records to corresponding to the genuine, unique identifiers. A verification card is supplied to the non-consumer, e.g., the wholesaler, distributor, retailer, etc., as shown in box 96. The wholesaler, distributor or retailer contacts the verification center at box 98 and conveys the unique identifier from the verification card. The database records are polled as at box 16. If the unique identifier is valid and has not been previously conveyed, a series of additional unique identifiers relating to all the goods in the particular shipment are validated, at box 100. (Validation of unique identifiers, i.e., providing information to the system that certain identifiers are valid, is not the same as confirming the validity (authenticity) of a particular product. It would be the manufacturer that validates the unique identifier, i.e., the manufacturer indicates to the system that authorized products have been shipped and indicates the unique identifier associated with those authorized or authentic products. Thereafter, when consumers contact the verification center to verify authenticity of their individual purchases, the database has already been updated to validate the identifiers based on verification of the wholesaler's identifier. In this fashion, the unique identifiers, although randomly generated, can be verified in a multi-step process where the wholesaler, distributor and/or retailer must first validate an identifier which, in turn, releases a sub-group of identifiers for subsequent verification. Thus in the context of a multi-step or multi-tier or multi-level verification, the ultimate user may not be the first purchaser of the product, rather, a wholesaler may be considered a first purchaser.

A variety of modifications to the embodiments described will be apparent to those skilled in the art from the disclosure provided herein. Thus, the system, apparatus and method may be embodied in other specific forms without departing from the spirit or essential attributes thereof and, accordingly, reference should be made to the appended claims, rather than to the foregoing specification, as indicating the scope of the invention.

1-20. (canceled)

21. A method of verifying the authenticity of a product, the method comprising:
receiving a verification device in association with a product whose authenticity is to be verified, the verification device having an identifier;
conveying the identifier to a verification center; and
receiving a response by a recipient informing the recipient whether the product is authentic.

22. A method according to claim 21, wherein the identifier is conveyed to the verification center via telephone, or internet, or computer, or wireless, or cellular phone, or VoIP, or combinations thereof.

23. A method according to claim 21, wherein the identifier is unique for an individual product.

24. A method according to claim 21, wherein the identifier is unique for a group of products.

25. A method according to claim 21, further including, if the identifier is genuine and has not previously been conveyed, informing the recipient that the product is authentic.

26. A method according to claim 21, further including, if the identifier is genuine and has previously been conveyed, informing the recipient that the product may be counterfeit.

27. A method according to claim 21, further including, if the identifier is genuine and has previously been conveyed, informing the recipient that the product may be counterfeit if the recipient has not previously conveyed the identifier.

28. A method according to claim 21, wherein the recipient is provided with an incentive for verifying the authenticity of a product.

29. A method according to claim 28, wherein the incentive is a preselected amount of time for pre-paid telephone usage.

30. A method according to claim 28, wherein the incentive is a pre-paid telephone calling card.

31. A method according to claim 21, wherein the verification device is a pre-paid telephone calling card.

32. A method according to claim 31, further including the steps of;
recording in a database the value of the pre-paid telephone calling card, and
informing the recipient of the amount of time available on the pre-paid telephone calling card.

33. A method according to claim 21, wherein the verification device is packaged with the product.

34. A method according to claim 21, further including the steps of:
receiving a verification device by a second recipient in association with a product whose authenticity is to be verified, the verification device having a unique identifier;
conveying the identifier to a verification center; and
receiving a response informing the second recipient whether the product is authentic.

35. A method according to claim 34, wherein the recipient is a consumer.

36. A method according to claim 34, wherein the second recipient is a representative of a manufacturer.

37. A method according to claim 34, wherein the second recipient obtains a group of products, and the recipient obtains a product from said first group of products.

38. A method according to claim 37, wherein the unique identifier for said product is verified only if the unique identifier for said group of products has been conveyed to a verification center.

39. A method according to claim 21, further including the step of prompting the recipient to convey the identifier to the verification center.

40. A method according to claim 21, further including masking the unique identifier.

41. A method according to claim 21, further including the step of:
maintaining a database of unique identifiers; and
checking the database in response to the conveying of the unique identifier to the verification center to determine if the unique identifier is genuine.

42. The method of claim 41, further including the step of recording a record in said database indicating that the unique identifier has been conveyed.

43. The method of claim 41, further including the step of checking the database to determine if unique identifier has previously been conveyed to the verification center.

44. The method of claim 21, further including the step of maintaining a verification center.
